(19) United States
(12) Patent Application Publication
(10) Pub. No.: US 2008/0168933 A1
(43) Pub. Date: Jul. 17, 2008

(54) Seeding apparatus

(76) Inventor: John E. Setko, New Boston, MI (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(21) Appl. No.: 11/653,742

(22) Filed: Jan. 16, 2007

(51) Int. Cl. A01C 5/02

(52) U.S. Cl. 111/92

(57) ABSTRACT

An example seeding apparatus is disclosed which comprises a frame having a first end and a second end. The frame is configured to enable a person to use the seeding apparatus in a generally standing position. The seeding apparatus also includes a handle attached to the first end of the frame and an aeration mechanism attached to the second end of the frame. The seeding apparatus further includes a seed dispenser and a fertilizer dispenser. The aeration mechanism is operative to create a seeding environment in a portion of ground. The seed dispenser is operative to dispense seed onto the seeding environment, and the fertilizer dispenser is operative to fertilize the seed within the seeding environment.

### BACKGROUND OF THE INVENTION

1. Field of the Invention

The present invention relates generally to devices for seeding and maintaining grass or turf. More specifically, the present invention relates to a self-contained apparatus for seeding which can be used to patch areas of grass or turf.

2. Description of the Related Art

Apparatus for seeding grass or turf are well known. Such apparatus are useful for building and maintaining turf, and find particular utility for maintaining a residential lawn, a commercial lawn, a golf course or sports field, for example. Traditionally, in order to seed a patch of lawn, regardless of the size of the patch, one would need a variety of equipment and lawn products. For example, one may use a rake to remove the dead grass and debris from the bare patch. Next, one may use a spading fork or cultivating tool to loosen the soil in the bare area. Then one may apply seed, compost and/or fertilizer to the area. All of the tools and supplies may be transported by a wheel barrow or the like. As described, such a process requires one to locate, collect and return several disparate garden utensils and lawn products from their stored locations within a tool or garden work area.

While combinations of the prior art apparatus are adequate for seeding in certain contexts, there is no prior art apparatus that provides the simplicity and efficiency of the present invention. Further, employing several prior art apparatus for seeding requires excessive preparation and cleanup time and may result in excessive wear to the surrounding turf.

### SUMMARY OF THE INVENTION

It is an object of the present invention to provide a self-contained apparatus for seeding and fertilizing limited ground area.

According to a first aspect of the present invention, a first example seeding apparatus is provided. The seeping apparatus comprises a frame which has a first end and a second end. The frame is configured to enable a person to use the seeding apparatus in a generally standing position. The seeding apparatus also includes a handle attached to the first end of the frame and an aeration mechanism attached to the second end of the frame. The seeding apparatus further includes a seed dispenser and a fertilizer dispenser. The aeration mechanism is operative to create a seeding environment in a portion of ground; the seed dispenser is operative to dispense seed onto the seeding environment; and the fertilizer dispenser is operative to fertilize the seed within the seeding environment.

The objects, features and advantages of the present invention are readily apparent from the following description of the preferred embodiments when taken in connection with the accompanying drawings.

### BRIEF DESCRIPTION OF THE DRAWINGS

Comprehension of the invention is facilitated by reading the following detailed description, in conjunction with the associated drawings, in which:

FIG. 1 is a right side view of an example seeding apparatus in accordance with the present invention;

FIG. 2 is a magnified right side partially cutaway view of the first end of the example seeding apparatus of FIG. 1;

FIG. 3 is magnified right side partially cutaway view of the second end of the example seeding apparatus of FIG. 1; and

FIG. 4 is magnified bottom view of the second end of the example seeding apparatus of FIG. 1.

### DRAWING REFERENCE NUMERALS

The following reference characters identify the associated elements depicted in the drawings describing the present invention:
100 Seeding apparatus
102 Frame
104 Handle
106 Aeration mechanism
108 Seed dispenser
110 Seed dispensing actuator
112 Fertilizer holder
114 Fertilizer dispenser
202 Piston
204 Regulator control line
302 Seed container
304 Seed container base
306 Seed regulator
308 Spring
401 Rotatable drum
402 Aeration tine
404 Tine cleaning mechanism
406 Aeration mechanism housing

### DETAILED DESCRIPTION OF THE DRAWINGS

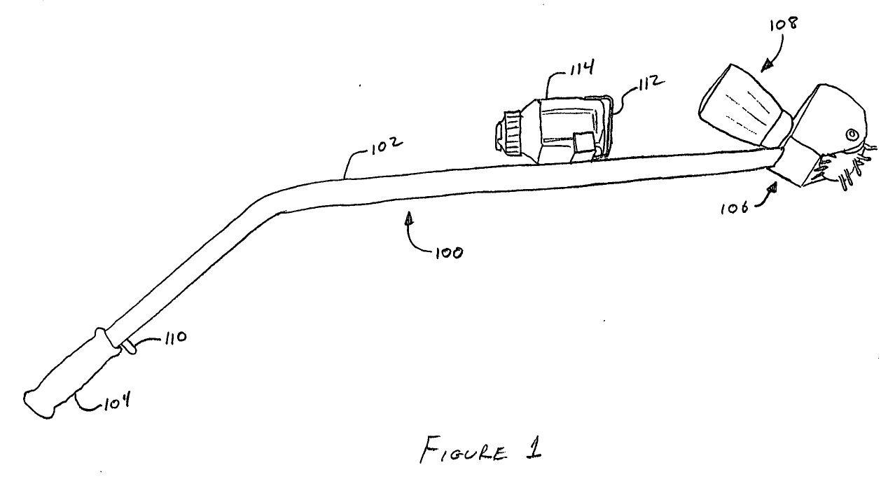

Generally, the present invention is directed to an apparatus for seeding turf and other ground cover. Referring now to the drawing figures, FIGS. 1-4 depict seeding apparatus 100 which is an example embodiment of the present invention. Seeding apparatus 100 is a hand-held tool which is intended to be used by a gardener, grounds keeper or home owner, for example, to seed and/or repair limited areas of a lawn or field. Seeding apparatus 100 includes a frame 102 which is bent to enable a user to comfortably use the apparatus from a generally standing position. Frame 102 supports a handle 104 at a first end and an aeration mechanism 106 at a second end. Example seeding apparatus 100 further includes a seed dispenser 108 disposed toward the second end, a seed dispending actuator disposed toward the first end and a fertilizer dispenser 114 along the central portion of frame 102. Fertilizer dispenser is removably attached to frame 102 by fertilizer holder 112.

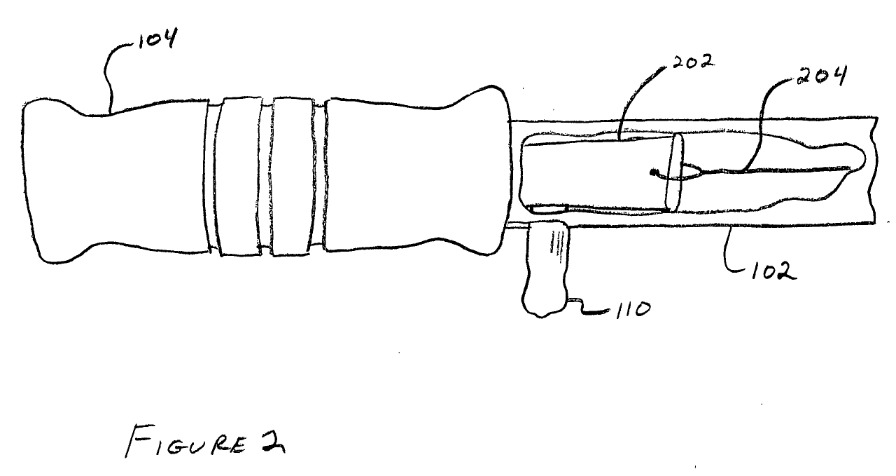

Referring now to FIG. 2, the first end of seeding apparatus 100 is shown in a magnified right side partially cutaway view. Handle 104 is disposed at the first end of seeding apparatus 100. Although the example handle 104 is illustrated as a separate element, the first end of frame 102 could operate as a handle or frame 102 could employ a handle that is integrated with the frame 102, such as one constructed from molded plastic or similar material.

With continuing reference to FIG. 2, there is illustrated seed dispensing actuator 110 for controlling the dispensing of seed by seed dispenser 108. Actuator 110 is configured to slide between a first position and a second position. When actuator 110 is disposed in the first position, as illustrated in FIG. 2, seed dispenser 108 is closed. When tension is applied to actuator 110 in the direction of the first end of seeding apparatus 100, actuator 110 slides to the second position. When actuator 110 is disposed in the second position, seed dispenser 108 is opened allowing seed to be dispensed onto a prepared patch of ground.

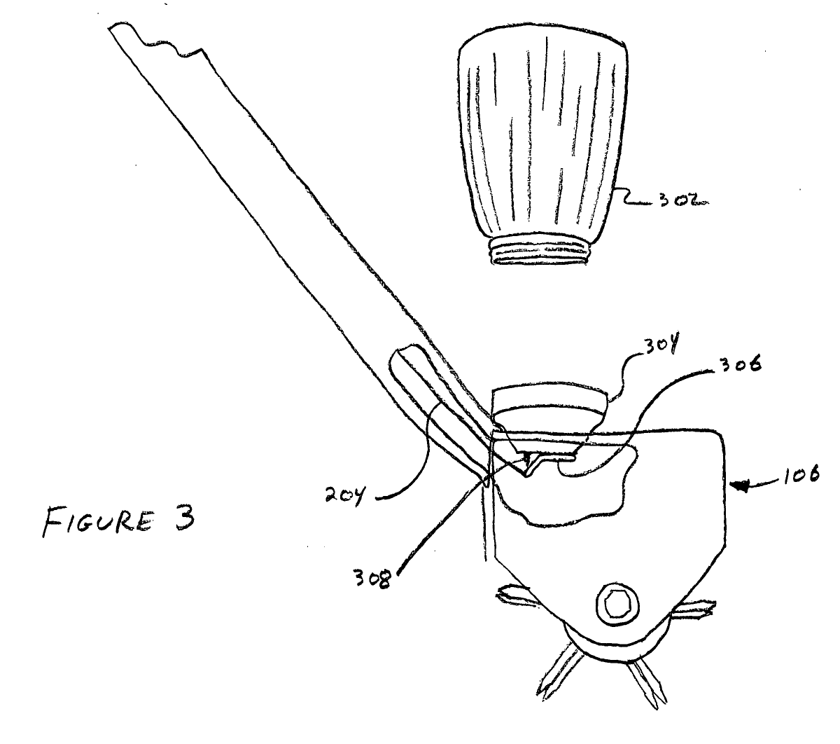

Actuator 110 is connected to a piston 202 which is configured to slide between a corresponding first position and second position within frame 102. Piston 202 is connected to regulator control line 206 which controls a seed regulator 306 illustrated in FIG. 3.

Referring now to FIG. 3, there is illustrated a magnified, partially cutaway, view of the second end of example seeding apparatus 100. As shown, seed dispenser 108 includes a seed container 302 which is attached to dispenser base 304. Dispenser base 304 forms an aperture at the lower end which allows seed to be gravity fed from the container 302 onto the patch of ground to be seeded.

The aperture of dispenser base 304 is covered by seed regulator 306 when actuator 110 is in the first position, and the aperture of dispenser base 304 is uncovered by seed regulator 306 when actuator 110 is in the second position. Seed regulator 306 cooperates with a tension means, such as spring 308, which maintains seed regulator 306 in the first position when no opposing tension is applied via actuator 110.

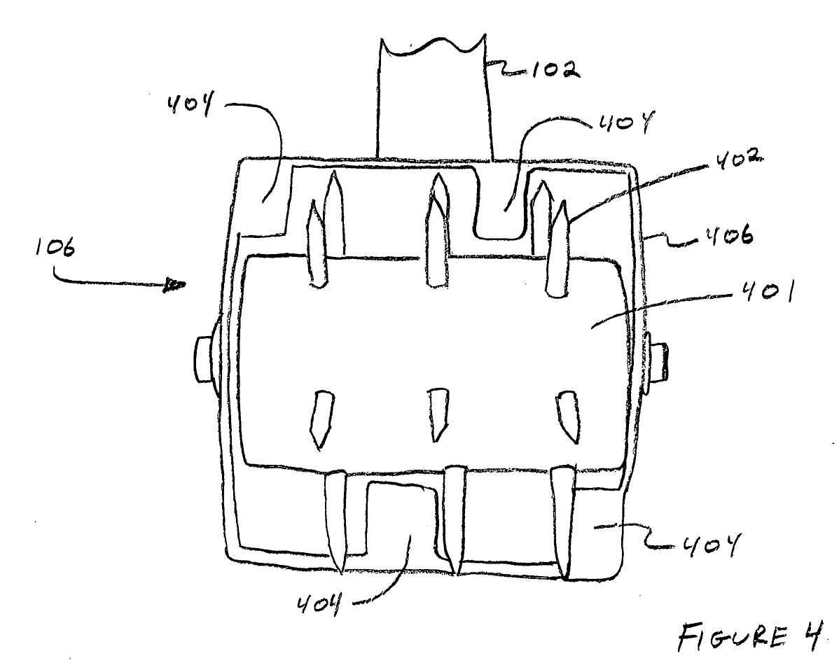

Referring now to FIG. 4, there is shown a magnified bottom view of the second end of example seeding apparatus 100. Aeration mechanism 106 is shown in greater detail. Aeration mechanism 106 includes a plurality of tines or prongs 402, attached to rotatable drum 401, which serve to prepare a patch of ground for accepting seed and fertilizer. Aeration mechanism 106 includes a housing 406 and a tine cleaning mechanism 404 comprising a plurality of cleaning flaps.

To use the present invention, an area of ground is selected for reseeding. The user rolls the second end of the seeding device over the selected area of ground. The tines of the aeration mechanism work the ground thereby aerating, cleaning and preparing the ground for accepting seed and fertilizer. Once the ground is properly conditioned, the user continues to work the ground with the aeration mechanism while simultaneously engaging the seed dispensing actuator, thereby dispensing seed onto the prepared ground, and working the seed into the soil. Finally, the user removes the fertilizer dispenser from the device and dispenses fertilizer onto the prepared and seeded area.

Although the invention has been described in terms of specific embodiments and applications, persons skilled in the art can, in light of this teaching, generate additional embodiments without exceeding the scope or departing from the spirit of the claimed invention. Accordingly, it is to be understood that the drawing and description in this disclosure are proffered to facilitate comprehension of the invention, and should not be construed to limit the scope thereof.

What is claimed is:

1. A seeding apparatus, comprising:
a frame, the frame having a first end and a second end, the frame configured to enable a person to use the seeding apparatus in a generally standing position;
a handle attached to the first end of the frame;
an aeration mechanism attached to the second end of the frame;
a seed dispenser attached to the seeding apparatus; and
a fertilizer dispenser attached to the seeding apparatus;
whereby the aeration mechanism is operative to create a seeding environment in a portion of ground, the seed dispenser is operative to dispense seed onto the seeding environment, and the fertilizer dispenser is operative to fertilize the seed within the seeding environment.

2. The seeding apparatus of claim 1, wherein the seed dispenser is attached to the frame, and the seeding apparatus further comprises:
a seed dispensing actuator in cooperation with the seed dispenser, the actuator movable between a first position in which the seed dispenser is closed and a second position in which the seed dispenser forms an aperture through which seed is dispensed.

3. The seeding apparatus of claim 1, wherein the fertilizer dispenser is detachably connected to the frame.

4. The seeding apparatus of claim 1, wherein the seed dispenser is attached to the aeration mechanism.

5. The seeding apparatus of claim 1, wherein the frame generally forms an obtuse angle.

6. The seeding apparatus of claim 1, wherein the aeration mechanism includes a plurality of rotatable tines.

7. The seeding apparatus of claim 6, wherein the aeration mechanism includes at least one cleaning mechanism.

8. A seeding apparatus, comprising:
a frame, the frame having a first end and a second end, the frame configured to enable a person to use the seeding apparatus in a generally standing position;
a handle attached to the first end of the frame;
an aeration mechanism attached to the second end of the frame, the aeration mechanism including a rotatable drum and a plurality of tines attached to the drum;
a seed dispenser attached to the aeration mechanism, the seed dispenser including a seed container, a seed base and a seed regulator, the seed base forming an aperture and the seed regulator movable between a first position in which the aperture is covered by the seed regulator and a second position in which the aperture is at least partially uncovered by the seed regulator;
an actuator in communication with the seed regulator; and
a fertilizer dispenser attached to the seeding apparatus;
whereby the aeration mechanism is operative to create a seeding environment in a portion of ground, the seed dispenser is operative to dispense seed onto the seeding environment when the seed regulator is disposed in the second position, and the fertilizer dispenser is operative to fertilize the seed within the seeding environment.

9. The seeding apparatus of claim 1, wherein the fertilizer dispenser is detachably connected to the frame.

10. The seeding apparatus of claim 1, wherein the frame generally forms an obtuse angle.

11. The seeding apparatus of claim 8, wherein the aeration mechanism includes at least one cleaning mechanism.

12. The seeding apparatus of claim 11, wherein the aeration mechanism comprising a housing which forms the least one cleaning mechanism.
